(19) United States
(12) Patent Application Publication
(10) Pub. No.: US 2015/0106583 A1
(43) Pub. Date: Apr. 16, 2015

(54) STORAGE SPACE MAPPING METHOD AND APPARATUS

(71) Applicant: Huawei Technologies Co., Ltd., Shenzhen (CN)

(72) Inventor: Wei Zhou, Hangzhou (CN)

(21) Appl. No.: 14/573,977

(22) Filed: Dec. 17, 2014

Related U.S. Application Data
(63) Continuation of application No. PCT/CN2013/070055, filed on Jan. 5, 2013.

(30) Foreign Application Priority Data
Jun. 20, 2012 (CN) 201210204676.3

(51) Int. Cl. G06F 3/06

(52) U.S. Cl. CPC G06F 3/0626; G06F 3/0629; G06F 3/0673
USPC 711/170

(57) ABSTRACT

Embodiments of the present invention provide a storage space mapping method and apparatus. The method includes: parsing source code, so as to acquire a home file and/or a home folder of each function and/or variable in the source code; acquiring a mapping relationship between the home file and a storage area identifier and/or between the home folder and a storage area identifier, and establishing, according to the mapping relationship, a mapping relationship between each function and/or variable and the storage area identifier; and mapping, according to a mapping relationship between the storage area identifier and storage space, each function and/or variable to the storage space. According to the storage space mapping method and apparatus provided in the embodiments of the present invention, development workload and maintenance costs of storage space mapping can be greatly reduced.

### CROSS-REFERENCE TO RELATED APPLICATIONS

This application is a continuation of International Application No. PCT/CN2013/070055, filed on Jan. 5, 2013, which claims priority to Chinese Patent Application No. 201210204676.3, filed on Jun. 20, 2012, both of which are hereby incorporated by reference in their entireties.

### TECHNICAL FIELD

The present invention relates to the field of computer technologies, and in particular, to a storage space mapping method and apparatus.

### BACKGROUND

A computer system has certain requirements for three basic performance indicators: a capacity, a speed, and a price of a storage. However, these three performance indicators are generally contradictory to each other, and a single storage formed by using only one type of technology cannot meet these three performance indicators at the same time. Therefore, in the prior art, by using a storage system formed by a multi-tier storage, several types of storage technology are combined to better resolve a contradiction among a large capacity, a high speed, and a low cost of a storage. For example, in current development of a digital signal processing (Digital Signal Processing, DSP) embedded chip, a multi-tier storage manner is generally used to deploy development code on memories at different tiers, so as to take full advantage of a memory at each tier in speed, capacity, and cost and achieve an optimal cost-performance ratio.

A current multi-tier storage manner is implemented in a manner of adding a section attribute to source code. Specifically, some sections are predefined. In source code written by a user, a section attribute is added in front of each variable and function separately, that is, a section is configured for each variable and function; a mapping relationship between each variable and function and the section is established, and a mapping relationship between the section and a specified memory is established by modifying a link script, so as to determine a storage location, in the memory, of each variable and function involved in the source code.

In a process of implementing the current multi-tier storage manner, configuration needs to be performed for each symbol (variable or function) separately, which is relatively complex. In addition, in a current embedded product, a set of source code generally has tens of thousands of symbols, which results in excessively heavy development workload and high maintenance costs.

### SUMMARY

Embodiments of the present invention provide a storage space mapping method and apparatus, so as to overcome a defect in the prior art that a storage space mapping relationship needs to be separately configured for each variable or function in source code, thereby reducing complexity of implementing a multi-tier storage manner, and reducing development workload and maintenance costs.

According to one aspect, an embodiment of the present invention provides a storage space mapping method, including:

parsing source code, so as to acquire a home file and/or a home folder of each function and/or variable in the source code;

acquiring a mapping relationship between the home file and a storage area identifier and/or between the home folder and a storage area identifier, and establishing, according to the mapping relationship, a mapping relationship between each function and/or variable and the storage area identifier; and

mapping, according to a mapping relationship between the storage area identifier and storage space, each function and/or variable to the storage space.

According to another aspect, an embodiment of the present invention provides a storage space mapping apparatus, and the apparatus includes:

a source code parsing module, configured to parse source code, so as to acquire a home file and/or a home folder of each function and/or variable in the source code;

a first mapping module, configured to acquire a mapping relationship between the home file and a storage area identifier and/or between the home folder and a storage area identifier, and establish, according to the mapping relationship, a mapping relationship between each function and/or variable and the storage area identifier; and

a second mapping module, configured to map, according to a mapping relationship between the storage area identifier and storage space, each function and/or variable to the storage space.

According to the storage space mapping method and apparatus in the embodiments of the present invention, source code is parsed, so as to acquire a homing relationship between each function and/or variable in the source code and a file or a folder, and according to a storage area identifier that is configured for the file or the folder, a mapping relationship between a function and a variable that belong to a corresponding file or folder and the storage area identifier is established. Therefore, separate configuration does not need to be separately performed for a great number of functions and variables in the source code; instead, configuration needs to be performed only for the file or the folder, and then all functions and variables can be automatically mapped to a specified storage area identifier, and further mapped to specified storage space, which reduces complexity of implementing a multi-tier storage manner, reduces development workload, makes it easy to modify, and reduces maintenance costs.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic flowchart of a storage space mapping method according to an embodiment of the present invention;

FIG. 2 is a schematic diagram of a storage structure of a multi-tier storage system;

FIG. 3 is an example of a project structure; and

FIG. 4 is a schematic structural diagram of a storage space mapping apparatus according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

### Embodiment 1

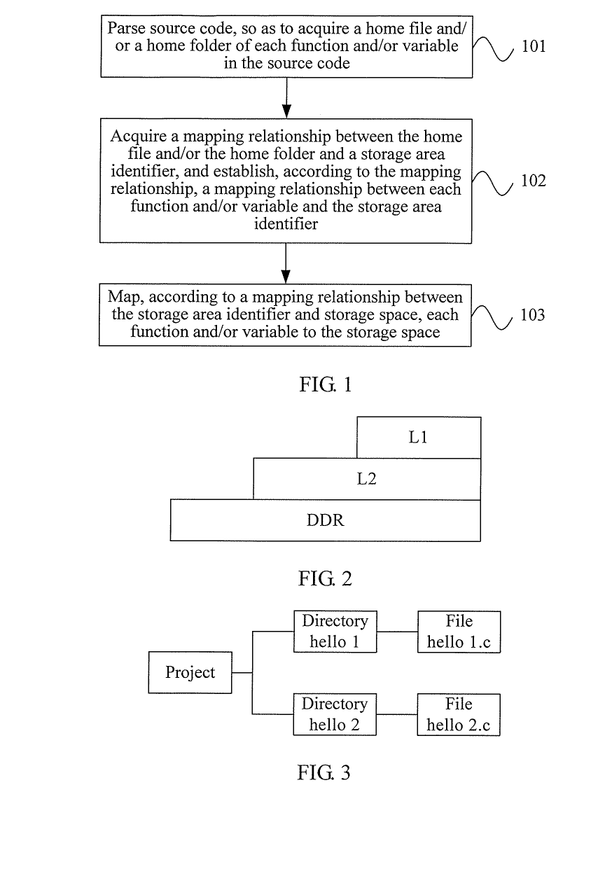

FIG. 1 is a schematic flowchart of a storage space mapping method according to an embodiment of the present invention. Specifically, as shown in FIG. 1, the storage space mapping method includes the following steps:

Step 101: Parse source code, so as to acquire a home file and/or a home folder of each function and/or variable in the source code.

Step 102: Acquire a mapping relationship between the home file and a storage area identifier and/or between the home folder and a storage area identifier, and establish, according to the mapping relationship, a mapping relationship between each function and/or variable and the storage area identifier.

Step 103: Map, according to a mapping relationship between the storage area identifier and storage space, each function and/or variable to the storage space.

Specifically, the storage space mapping method of this embodiment is described in detail by assuming an application scenario in which the storage space mapping method of this embodiment is used to map and store a project file to storage space of a multi-tier storage system. The application scenario is used only as an example of technical solutions of the present invention, instead of a limitation on the present invention. A person skilled in the art can understand that the technical solutions of the present invention are applicable to any scenario in which batch configuration needs to be performed on a function and a variable in a file or a folder, such as invoking of an inline function (inline).

FIG. 2 is a schematic diagram of a storage structure of a multi-tier storage system. As shown in FIG. 2, the multi-tier storage system includes, for example, L1 storage space, L2 storage space, and a double data rate synchronous dynamic random access memory (Double Data Rate Synchronous Dynamic Random Access Memory, DDR for short). FIG. 3 is an example of a project structure. As shown in FIG. 3, the project includes a directory (that is, a folder) hello 1 and a directory hello 2; a file hello 1.c is saved in the directory hello 1, and a file hello 2. c is saved in the directory hello 2. The following is described with reference to FIG. 2 and FIG. 3.

Firstly, some storage area identifiers are defined, and these storage area identifiers do not specify actual storage space in a storage area. For example, the storage area identifiers are defined in the following manner:

“#define L1_DATA_attribute_(section (“.11.data”))”;

“#define L1_TEXT_attribute_(section (“.12.text”))”;

“#define L2_DATA_attribute_(section (“.11.data”))”;

“#define L2_TEXT_attribute_(section (“.12.text”))”;

By using the foregoing statements, four storage area identifiers “L1_DATA”, “L1_TEXT”, “L2_DATA”, and “L2_TEXT” are defined, where “L1_DATA” is used to indicate storage space that is used to store a variable at an L1 layer, “L1_TEXT” is used to indicate storage space that is used to store a function at the L1 layer, “L2_DATA” is used to indicate storage space that is used to store a variable at an L2 layer, and “L2_TEXT” is used to indicate storage space that is used to store a function at the L2 layer.

Subsequently, a storage area identifier is configured at a file (or folder) level, that is, a storage area identifier is allocated to each file (or folder), and a mapping relationship between the file (or folder) and the storage area identifier is established. For example, “L1_DATA” and “L1_TEXT” are configured for the file hello 1.c, and “L2_DATA” and “L2_TEXT” are configured for the hello2.c.

Project source code written by a user is read, and by morphological and grammatical analysis, each function and variable in the source code, and a home file path of each function or variable (that is, a file or a folder to which each function or variable belongs) are acquired. For example, after the project source code is read, two source code files hello1.c and hello 2.c in the project source code are acquired, where the source code file hello1.c, for example, is:

#include ″hello.h″
int a;
int b;
int funa ( )
{
. . .
}
int funb ( )
{
. . .
}
funcint func ( )
{
. . .
}

and the source code file hello 2.c, for example, is:

#include ″hello.h″
int x;
int y;
int funx( )
{
. . .
}
int funy ( )
{
. . .
}
int funz ( )
{
. . .
}

Afterwards, according to a storage area identifier corresponding to a file (folder) to which each function or variable belongs, a mapping relationship between each function or variable and the storage area identifier is established. With reference to the foregoing examples of the hello1.c and the hello2.c, because a variable a, a variable b, a function funa( ), a function funb( ) and a function func( ) belong to the file hello1.c, the storage area identifier “L1_DATA” is configured for the variable a and the variable b, and the storage area identifier “L1_TEXT” is configured for the function funa( ), the function funb( ), and the function func( ); because a variable x, a variable y, a function funx( ) a function funy( ), and a function funz( ) belong to the file hello2.c, the storage area identifier “L2_DATA” is configured for the variable x and the variable y, and the storage area identifier “L2_TEXT” is configured for the function funx( ) the function funy( ) and the function funz( ).

After mapping between the foregoing functions or variables and the storage area identifiers is complete, code, which identifies a mapping relationship between a function or a variable and a storage area identifier, of the hello 1.c is shown as follows:

#include ″hello.h″
L1_DATA int a;
L1_DATA int b;
L1_TEXT int funa ( )
{
. . .
}
L1_TEXT int funb ( )
{
. . .
}
L1_TEXT int func ( )
{
. . .
}

Code, which identifies a mapping relationship between a function or a variable and a storage area identifier, of the hello 2.c is shown as follows:

#include ″hello.h″
L2_DATA int x;
L2_DATA int y;
L2_TEXT int funx( )
{
. . .
}
L2_TEXT int funy( )
{
. . .
}
L2_TEXT int funz( )
{
. . .
}

The foregoing code that identifies a mapping relationship between a function or a variable and a storage area identifier may be compiled into a file that can be redirected, and a mapping relationship between a storage area identifier and specified storage space is established by modifying a link script. Methods for compiling the file that can be redirected and modifying the link script are the same as those in the prior art; therefore, details are not described herein again. For example, the link script is modified as follows:

.11.text
{
.=ALIGN (16) ;
* (.11.text)
.=ALIGN (16) ;
}>L1TEXT_seg: L1TEXT_phdr
.11.data:
{
.=ALIGN (16) ;
* (.11. data)
.=ALIGN (16) ;
}>L1DATA_seg: L1DATA_phdr
.12.text
{
.=ALIGN (16) ;
* (.12.text)
.=ALIGN (16) ;
}>L2TEXT_seg: L2TEXT_phdr
.12.data:
{
.=ALIGN (16) ;
* (.12. data)
.=ALIGN (16) ;
}>L2DATA_seg: L2DATA_phdr

L1TEXT_seg, L1DATA_seg, L2TEXT_seg, and L2DATA_seg are the specified storage space.

An image file is generated by linking the file that can be redirected and the link script together. In this case, storage space of each variable and function in the project code is determined, where each variable and function in the project code are deployed in a multi-tier storage system. Mapping of each function and variable to the storage space may be mapping of the function and variable to a specific storage address in single-tier storage space, and may also be mapping of the function and variable to storage space at a certain tier in multi-tier storage space. A method for generating the image file is the same as that in the prior art; therefore, details are not described herein again. For example, the foregoing example is used to implement the following deployment: deploying the variable a and the variable b in the specified storage space L1DATA_seg; deploying the function funa( ), the function funb( ), and the function func( ) in the specified storage space L1TEXT_seg; deploying the variable x and the variable y in the specified storage space L2DATA_seg; and deploying the function funx( ), the function funy( ), and the function funz( ) in the specified storage space L2TEXT_seg.

According to the storage space mapping method in the foregoing embodiment, source code is parsed, so as to acquire a homing relationship between each function and/or variable in the source code and a file or a folder, and according to a storage area identifier that is configured for the file or the folder, a mapping relationship between a function and a variable that belong to a corresponding file or folder and the storage area identifier is established. Therefore, separate configuration does not need to be separately performed for a great number of functions and variables in the source code; instead, configuration needs to be performed only for the file or the folder, and then all functions and variables can be automatically mapped to a specified storage area identifier, and further mapped to specified storage space, which reduces complexity of implementing a multi-tier storage manner, reduces development workload, makes it easy to modify, and reduces maintenance costs.

### Embodiment 2

Based on the foregoing Embodiment 1, the acquiring a mapping relationship between the home file and a storage area identifier and/or between the home folder and a storage area identifier, and establishing, according to the mapping relationship, a mapping relationship between each function and/or variable and the storage area identifier specifically includes:

parsing a configuration file, and establishing the mapping relationship between each function and/or variable and the storage area identifier according to a pre-created configuration file and the home file and/or the home folder of each function and/or variable, where the configuration file includes the mapping relationship between the home file and/or the home folder and the storage area identifier.

Specifically, a configuration file is created, and a mapping relationship between a file (or a folder) and the storage area identifier is established and stored in the configuration file. A configuration granularity of the storage area identifier is above a file level, and each file (or folder) includes both a function and a variable; therefore, in the configuration file, the variable and the function in the file are separately configured.

For example, the following configuration file is created:

```
  ″<file>
  <item name=″ . /test/ hello1/hello1.c ″ CodeSection=″Ll_TEXT″
TextSection=″Ll_DATA″/>
  <item name=″ ./test/hello2/hello2.c″ CodeSection =″L2_TEXT″
TextSection=″L2_DATA″/>
  </file>″
```

<file> represents configuration at a file level. In the foregoing configuration file, a storage area identifier L1_DATA is configured for a variable in a file hello 1.c, a storage area identifier L1_TEXT is configured for a function in the file hello 1.c, a storage area identifier L2_DATA is configured for a variable in a file hello 2.c, and a storage area identifier L2_TEXT is configured for a function in the file hello 2.c. After the foregoing configuration file is created, when storage space mapping needs to be performed, the mapping relationship between the file (or the folder) and the storage area identifier is acquired by parsing the configuration file. With reference to a homing relationship, which is acquired by parsing source code, between a function and/or a variable and a file (or a folder), a mapping relationship between each function and/or variable and the storage area identifier can be established.

Further, the configuration file further includes: a mapping relationship between a specified function and/or variable in the home file and/or the home folder and a storage area identifier, where a storage area identifier corresponding to the specified function and/or variable is different from a storage area identifier corresponding to the home file and/or the home folder of the specified function and/or variable.

Correspondingly, the establishing the mapping relationship between each function and/or variable and the storage area identifier according to a pre-created configuration file and the home file and/or the home folder of each function and/or variable specifically includes:

establishing, according to the storage area identifier that is corresponding to the specified function and/or variable and is in the configuration file, the mapping relationship between the specified function and/or variable and the storage area identifier; and

establishing, according to the storage area identifier that is corresponding to the home file and/or the home folder and is in the configuration file, a mapping relationship between each of another function and/or variable and the storage area identifier, where each of the another function and/or variable is a function and/or a variable other than the specified function and/or variable in the home file and/or the home folder.

The specified function and/or variable may be any function and/or variable in the home file and/or the home folder. More specifically, configurations of different granularities may be performed in the configuration file. For example, for a directory (that is, a folder), a file, a function, and a variable, any two or more than two levels may be configured at the same time. When configuration of two or more than two levels exists, configuration of a smaller granularity has a higher priority.

For example, the following configuration file is created:

| | |
|---|---|
| ″<folder> | |
| <item name=″./test/hello1/″ | CodeSection=″L1_TEXT″ |
| TextSection=″L1_DATA″/> | |
| </folder> | |
| <file> | |
| <item name=″./test/hello2/hello2.c″ | CodeSection=″L2_TEXT″ |
| TextSection=″L2_DATA″/> | |
| </file> | |
| <var> | |
| <item name=″b″Section=″L2_DATA″/> | |
| </var> | |
| <func> | |
| <item name=″funy″ Section=″L1_TEXT″/> | |
| </func>″ | |

<folder> represents configuration at a directory (folder) level; <file> represents configuration at a file level; <var> represents configuration at a variable level; and <func> represents configuration at a function level. In the foregoing configuration file, the storage area identifier L1_DATA is configured for a variable in a directory hello 1, the storage area identifier L1_TEXT is configured for a function in the directory hello 1, the storage area identifier L2_DATA is configured for a variable in the file hello 2.c, the storage area identifier L2_TEXT is configured for a function in the file hello 2.c, the storage area identifier L2_DATA is configured for a variable b, and the storage area identifier L1_TEXT is configured for a function funy.

When a mapping relationship between a function and a variable and a storage area identifier is established according to the foregoing configuration file, mapping is performed, for example, in descending order of priority. Because configuration of a smaller granularity has a higher priority, configuration is performed first according to the specified variable b and function funy in the configuration file. That is, a mapping relationship between the variable b in the file hello 1.c and the storage area identifier L2_DATA is established, and a mapping relationship between the function funy in the file hello 2.c and the storage area identifier L1_TEXT is established. Subsequently, a mapping relationship between a corresponding function and variable and a storage area identifier is established according to file-level configuration in the configuration file; however, in this case, a mapping relationship of a variable and a function for which a mapping relationship has been established is not modified. With reference to the foregoing example, although the storage area identifier L2_TEXT is configured for a function in the hello 2.c, because in the configuration file, and the storage area identifier L1_TEXT is also configured for the function funy, although the function funy belongs to the file hello 2.c, the function funy is still mapped to the storage area identifier L1_TEXT, and another function other than the function funy in the file hello 2.c is mapped to the storage area identifier L2_TEXT.

Because the file hello 1.c is saved in the directory hello 1, the foregoing configuration for the directory hello 1 is equivalent to configuration for the file hello 1.c. That is, a variable in the file hello 1.c is mapped to the storage area identifier L1_DATA, and a function in the file hello 1.c is mapped to the storage area identifier L1_TEXT. In addition, if a file hello 3.c is also saved in the directory hello 1, and the file hello 3.c is not separately configured in the configuration file, the configuration for the file hello 1 is also applicable to the file hello 3.c; if the file hello 3.c is separately configured, a mapping relationship is established according to the separate configuration for the file hello 3.c, where the mapping relationship is between a function and a variable in the file hello 3.c, and a storage area identifier.

According to the storage space mapping method in the foregoing embodiment, storage area identifiers of different granularities are configured in a configuration file, so that mapping between a function and a variable and storage space is more flexible and diverse.

Further, creating the configuration file further includes:

setting a default storage area identifier in the configuration file; and

correspondingly, if, in the configuration file, the storage area identifier is configured for a part of the home file and/or the home folder, the establishing, according to the configuration file and the home file and/or the home folder of the function and/or variable, the mapping relationship between the function and/or the variable and the storage area identifier further includes:

establishing a mapping relationship between a function and/or a variable in the source code and the default storage area identifier, where the function and/or the variable belong/belongs to a file and/or a folder to which a storage area identifier is not allocated.

For example, in the configuration file, the default storage area identifier is set in the following manner:

<default>
<item CodeSection=″DDR_TEXT″ TextSection=″DDR_DATA″/>
</default>

By using the foregoing configuration, a storage area identifier DDR_TEXT is set to a default storage area identifier of a function, and a storage area identifier DDR_DATA is set to a default storage area identifier of a variable. If the directory hello 2 shown in FIG. 3 also includes a file hello 4.c, because in the configuration file, only the storage area identifier corresponding to the file hello 2.c is configured, configuration is not performed for the directory hello 2, and a storage area identifier corresponding to the configuration file hello 4.c is not configured either, when the configuration file is parsed and a mapping relationship between each variable and function in the source code and the storage area identifier is established according to the configuration file, a mapping relationship between a function in the file hello 4.c and the storage area identifier DDR_TEXT is established, and a mapping relationship between a variable in the file hello 4.c and the storage area identifier DDR_DATA is established.

According to the storage space mapping method in the foregoing embodiment, a default storage area identifier is provided in a configuration file. On one hand, when there are a great number of files or folders for which a storage area identifier does not need to be specially specified, workload for separately allocating a storage area identifier to each file or folder can be effectively reduced; on the other hand, when mapping of a storage area identifier of a part of files or folders is not configured in the configuration file, successful mapping of a function and a variable can still be ensured.

### Embodiment 3

Based on the foregoing Embodiment 1, the acquiring a mapping relationship between the home file and a storage area identifier and/or between the home folder and a storage area identifier, and establishing, according to the mapping relationship, a mapping relationship between each function and/or variable and the storage area identifier specifically includes:

detecting whether the source code carries a first rule that is used to indicate the mapping relationship between the home file and/or the home folder and the storage area identifier; and

when the source code carries the first rule that is used to indicate the mapping relationship between the home file and/or the home folder and the storage area identifier, establishing the mapping relationship between each function and/or variable and the storage area identifier according to the mapping relationship between the home file and/or the home folder and the storage area identifier in the first rule.

Specifically, for file-level storage, a configuration file does not need to be created; instead, a first rule is directly added to the source code, where the first rule is used to indicate the mapping relationship between the home file and/or the home folder and the storage area identifier. More specifically, for example, if a keyword #pragma is used to indicate the first rule, a format of the first rule, for example, is “#pragma section <storage area identifier>”.

For example, the file hello1.c is mapped to L1_DATA and L1_TEXT in the foregoing manner; then, code, in which the first rule is added, of the file hello1.c, for example, is:

#include ″hello.h″
#pragma section
<L1_TEXT>
<L1_DATA>
int a;
int b;
int funa ( )
{
. . .
}
int funb ( )
{
. . .
}
int func ( )
{
. . .
}

In addition, the first rule of the foregoing code may also carry only any one of the storage area identifiers L1_DATA and L1_TEXT. For example, if the first rule is “#pragma section <L1_TEXT>”, when the mapping relationship between the function and/or the variable and the storage area identifier is established, a fault tolerance function is performed by pre-configuration, and a function in the file hello1.c is mapped to the storage area identifier L1_TEXT, and a variable in the file hello1.c is mapped to the storage area identifier L1_DATA.

According to the storage space mapping method in this embodiment, a configuration file does not need to be established, and a storage area identifier can be configured for a file merely by adding an instruction to source code of the file, thereby further improving convenience and efficiency of storage space mapping.

Further, the acquiring a mapping relationship between the home file and a storage area identifier and/or between the home folder and a storage area identifier, and establishing, according to the mapping relationship between the home file and/or the home folder and the storage area identifier, a mapping relationship between the function and/or the variable and the storage area identifier further includes:

detecting, after the first rule is detected, whether the source code carries a second rule that is used to indicate a mapping relationship between a specified function and/or variable and a storage area identifier, where a storage area identifier corresponding to the specified function and/or variable in the second rule is different from a storage area identifier corresponding to the home file of the specified function and/or variable in the first rule; and

when the source code carries the second rule that is used to indicate a mapping relationship between a specified function and/or variable and a storage area identifier, establishing the mapping relationship between the specified function and/or variable and the storage area identifier according to the second rule, and establishing a mapping relationship between each of another function and/or variable and the storage area identifier according to the first rule, where each of the another function and/or variable is a function and/or a variable other than the specified function and/or variable in the home file.

Specifically, besides setting the foregoing first rule in the source code to specify a mapping relationship between a file and a storage area identifier, a storage area identifier may further be allocated to a function or a variable in the source code. An implementation manner of the second rule, for example, is the same as a manner of direct configuration for a function or a variable in the prior art; for example, a corresponding storage area identifier is directly added in front of a specified function or variable, and details are not described herein again. Correspondingly, in a process of establishing a mapping relationship between a function and/or a variable and a storage area identifier, if the second rule that allocates a storage area identifier to a specified function or variable exists, the mapping relationship between the specified function and/or variable and the storage area identifier is established according to the second rule; and for a function or a variable other than the specified function or variable in the file, a mapping relationship between the function or the variable and a storage area identifier is established according to the first rule.

According to the storage space mapping method in the foregoing embodiment, mapping between a function and a variable and storage space is more flexible and diverse.

### Embodiment 4

This embodiment provides an apparatus that is used to implement a storage space mapping method in the foregoing embodiments.

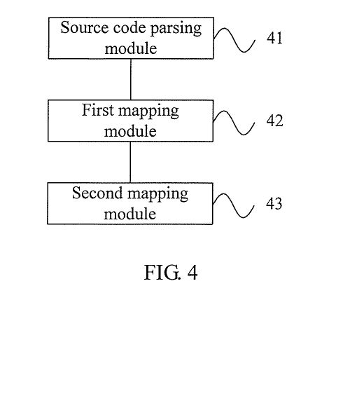

FIG. 4 is a schematic structural diagram of a storage space mapping apparatus according to an embodiment of the present invention. As shown in FIG. 4, the storage space mapping apparatus includes:

a source code parsing module 41, configured to parse source code, so as to acquire a home file and/or a home folder of each function and/or variable in the source code;

a first mapping module 42, configured to acquire a mapping relationship between the home file and a storage area identifier and/or between the home folder and a storage area identifier, and establish, according to the mapping relationship, a mapping relationship between each function and/or variable and the storage area identifier; and

a second mapping module 43, configured to map, according to a mapping relationship between the storage area identifier and storage space, each function and/or variable to the storage space.

A process of implementing storage space mapping by the storage space mapping apparatus in this embodiment is the same as the storage space mapping method in any of the foregoing embodiments; therefore, details are not described herein again.

According to the storage space mapping apparatus in this embodiment, source code is parsed, so as to acquire a homing relationship between each function and/or variable in the source code and a file or a folder, and according to a storage area identifier that is configured for the file or the folder, a mapping relationship between a function and a variable that belong to a corresponding file or folder and the storage area identifier is established. Therefore, separate configuration does not need to be separately performed for a great number of functions and variables in the source code; instead, configuration needs to be performed only for the file or the folder, and then all functions and variables can be automatically mapped to a specified storage area identifier, and further mapped to specified storage space, which reduces complexity of implementing a multi-tier storage manner, reduces development workload, makes it easy to modify, and reduces maintenance costs.

Further, the first mapping module includes:

a first mapping unit, configured to establish the mapping relationship between each function and/or variable and the storage area identifier according to a pre-created configuration file and the home file and/or the home folder of each function and/or variable, where the configuration file includes the mapping relationship between the home file and/or the home folder and the storage area identifier.

Further, the first mapping module further includes:

a configuration file creating unit, configured to create the configuration file and allocate the storage area identifier to the home file and/or the home folder in the configuration file.

Further, the configuration file further includes: a mapping relationship between a specified function and/or variable in the home file and/or the home folder and a storage area identifier, where a storage area identifier corresponding to the specified function and/or variable is different from a storage area identifier corresponding to the home file and/or the home folder of the specified function and/or variable; and

correspondingly, the first mapping unit is further specifically configured to: establish, according to the storage area identifier that is corresponding to the specified function and/or variable and is in the configuration file, the mapping relationship between the specified function and/or variable and the storage area identifier; and establish, according to the storage area identifier that is corresponding to the home file and/or the home folder and is in the configuration file, a mapping relationship between each of another function and/or variable and the storage area identifier, where each of the another function and/or variable is a function and/or a variable other than the specified function and/or variable in the home file and/or the home folder.

According to the storage space mapping apparatus in the foregoing embodiment, storage area identifiers of different granularities are configured in a configuration file that is created by a configuration file creating unit, so that mapping between a function and a variable and storage space is more flexible and diverse.

Further, the configuration file creating unit allocates, in the configuration file, the storage area identifier to a part of the home file and/or the home folder and sets, in the configuration file, a default storage area identifier; and

correspondingly, the first mapping unit is further configured to: establish a mapping relationship between a function and/or a variable in the source code and the default storage area identifier, where the function and/or the variable belong/belongs to a home file and/or a home folder to which a storage area identifier is not allocated.

According to the storage space mapping apparatus in the foregoing embodiment, a default storage area identifier is provided in a configuration file. On the one hand, when there are a great number of files or folders for which a storage area identifier does not need to be specially specified, workload for separately allocating a storage area identifier to each file or folder can be effectively reduced; on the other hand, when mapping of a storage area identifier of a part of files or folders is not configured in the configuration file, successful mapping of a function and a variable can still be ensured.

Further, the first mapping module includes:

a second mapping unit, configured to detect whether the source code carries a first rule that is used to indicate the mapping relationship between the home file and the storage area identifier, and when the source code carries the first rule that is used to indicate the mapping relationship between the home file and the storage area identifier, establish the mapping relationship between each function and/or variable and the storage area identifier according to the mapping relationship between the home file and the storage area identifier in the first rule.

According to the storage space mapping apparatus in the foregoing embodiment, a configuration file does not need to be created; instead, a storage area identifier can be configured for a file merely by adding an instruction to source code of the file, thereby further improving convenience and efficiency of storage space mapping.

Further, the second mapping unit is further configured to: detect, after the first rule is detected, whether the source code carries a second rule that is used to indicate a mapping relationship between a specified function and/or variable and a storage area identifier, where a storage area identifier corresponding to the specified function and/or variable in the second rule is different from a storage area identifier corresponding to the home file of the specified function and/or variable in the first rule; and when the source code carries the second rule that is used to indicate a mapping relationship between a specified function and/or variable and a storage area identifier, establish the mapping relationship between the specified function and/or variable and the storage area identifier according to the second rule, and establish a mapping relationship between each of another function and/or variable and the storage area identifier according to the first rule, where each of the another function and/or variable is a function and/or a variable other than the specified function and/or variable in the home file.

According to the storage space mapping apparatus in the foregoing embodiment, mapping between a function and a variable and storage space is more flexible and diverse.

Further, the second mapping module is specifically configured to map each function and/or variable to a storage address in single-tier storage space, or map each function and/or variable to storage space at a corresponding tier in multi-tier storage space.

A person of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is:

1. A storage space mapping method, comprising:
parsing source code, so as to acquire a home file of each function in the source code;
acquiring a mapping relationship between the home file and a storage area identifier, and establishing, according to the mapping relationship, a mapping relationship between each function and the storage area identifier; and
mapping, according to a mapping relationship between the storage area identifier and storage space, each function to the storage space.

2. The storage space mapping method according to claim 1, wherein acquiring a mapping relationship between the home file and a storage area identifier, and establishing, according to the mapping relationship, a mapping relationship between each function and the storage area identifier comprises:
establishing the mapping relationship between each function and the storage area identifier according to a pre-created configuration file and the home file of each function, wherein the configuration file comprises the mapping relationship between the home file and the storage area identifier.

3. The storage space mapping method according to claim 2, wherein:
the configuration file further comprises: a mapping relationship between a specified function in the home file and a storage area identifier, wherein a storage area identifier corresponding to the specified function is different from a storage area identifier corresponding to the home file of the specified function; and
correspondingly, establishing the mapping relationship between each function and the storage area identifier according to a pre-created configuration file and the home file of each function comprises:
establishing, according to the storage area identifier that is corresponding to the specified function, the mapping relationship between the specified function and the storage area identifier, and
establishing, according to the storage area identifier that is corresponding to the home file, a mapping relationship between each of another function and the storage area identifier, wherein each of the another function is a function other than the specified function in the home file.

4. The storage space mapping method according to claim 1, wherein acquiring a mapping relationship between the home file and a storage area identifier, and establishing, according to the mapping relationship, a mapping relationship between each function and the storage area identifier comprises:
detecting whether the source code carries a first rule that is used to indicate the mapping relationship between the home file and the storage area identifier; and
when the source code carries the first rule that is used to indicate the mapping relationship between the home file and the storage area identifier, establishing the mapping relationship between each function and the storage area identifier according to the mapping relationship between the home file and the storage area identifier in the first rule.

5. The storage space mapping method according to claim 4, further comprising:
detecting, after the first rule is detected, whether the source code carries a second rule that is used to indicate a mapping relationship between a specified function and a storage area identifier, wherein a storage area identifier corresponding to the specified function in the second rule is different from a storage area identifier corresponding to the home file of the specified function in the first rule; and
when the source code carries the second rule that is used to indicate a mapping relationship between a specified function and a storage area identifier, establishing the mapping relationship between the specified function and the storage area identifier according to the second rule, and establishing a mapping relationship between each of another function and the storage area identifier according to the first rule, wherein each of the another function is a function other than the specified function in the home file.

6. The storage space mapping method according to claim 1, wherein mapping, according to a mapping relationship between the storage area identifier and storage space, each function to the storage space comprises:
mapping each function to a storage address in single-tier storage space; or
mapping each function to storage space at a corresponding tier in multi-tier storage space.

7. A storage space mapping apparatus, comprising:
a source code parsing module, configured to parse source code, so as to acquire a home file of each function in the source code;
a first mapping module, configured to acquire a mapping relationship between the home file and a storage area identifier, and establish, according to the mapping relationship, a mapping relationship between each function and the storage area identifier; and
a second mapping module, configured to map, according to a mapping relationship between the storage area identifier and storage space, each function to the storage space.

8. The storage space mapping apparatus according to claim 7, wherein the first mapping module comprises:
a first mapping unit, configured to establish the mapping relationship between each function and the storage area identifier according to a pre-created configuration file and the home file of each function, wherein the configuration file comprises the mapping relationship between the home file and the storage area identifier.

9. The storage space mapping apparatus according to claim 8, wherein:
the configuration file further comprises: a mapping relationship between a specified function in the home file and a storage area identifier, wherein a storage area identifier corresponding to the specified function is different from a storage area identifier corresponding to the home file of the specified function; and
correspondingly, the first mapping unit is further configured to:
establish, according to the storage area identifier that is corresponding to the specified function, the mapping relationship between the specified function and the storage area identifier, and
establish, according to the storage area identifier that is corresponding to the home file, a mapping relationship between each of another function and the storage area identifier, wherein each of the another function is a function other than the specified function in the home file.

10. The storage space mapping apparatus according to claim 7, wherein the first mapping module comprises:
a second mapping unit, configured to detect whether the source code carries a first rule that is used to indicate the mapping relationship between the home file and the storage area identifier, and when the source code carries the first rule that is used to indicate the mapping relationship between the home file and the storage area identifier, establish the mapping relationship between each function and the storage area identifier according to the mapping relationship between the home file and the storage area identifier in the first rule.

11. The storage space mapping apparatus according to claim 10, wherein the second mapping unit is further configured to:
detect, after the first rule is detected, whether the source code carries a second rule that is used to indicate a mapping relationship between a specified function and a storage area identifier, wherein a storage area identifier corresponding to the specified function in the second rule is different from a storage area identifier corresponding to the home file of the specified function in the first rule; and
when the source code carries the second rule that is used to indicate a mapping relationship between a specified function and a storage area identifier, establish the mapping relationship between the specified function and the storage area identifier according to the second rule, and establish a mapping relationship between each of another function and the storage area identifier according to the first rule, wherein each of the another function is a function other than the specified function in the home file.

12. The storage space mapping apparatus according to claim 7, wherein the second mapping module is configured to:
map each function to a storage address in single-tier storage space; or
map each function to storage space at a corresponding tier in multi-tier storage space.

13. A storage space mapping method, comprising:
parsing source code, so as to acquire a home file of each variable in the source code;
acquiring a mapping relationship between the home file and a storage area identifier, and establishing, according to the mapping relationship, a mapping relationship between each variable and the storage area identifier; and
mapping, according to a mapping relationship between the storage area identifier and storage space, each variable to the storage space.

14. The storage space mapping method according to claim 13, wherein acquiring a mapping relationship between the home file and a storage area identifier, and establishing, according to the mapping relationship, a mapping relationship between each variable and the storage area identifier comprises:
establishing the mapping relationship between each variable and the storage area identifier according to a pre-created configuration file and the home file of each variable, wherein the configuration file comprises the mapping relationship between the home file and the storage area identifier.

15. A storage space mapping method, comprising:
parsing source code, so as to acquire a home file and home folder of each variable in the source code;
acquiring a mapping relationship between the home file and a storage area identifier and between the home folder and a storage area identifier, and establishing, according to the mapping relationship, a mapping relationship between each variable and the storage area identifier; and
mapping, according to a mapping relationship between the storage area identifier and storage space, each variable to the storage space.
